(19) United States
(12) Patent Application Publication
(10) Pub. No.: US 2012/0293715 A1
(43) Pub. Date: Nov. 22, 2012

(54) LIGHTING DEVICE, DISPLAY DEVICE AND TELEVISION RECEIVER

(75) Inventor: Nobuhiro Kasai, Osaka-shi (JP)

(73) Assignee: SHARP KABUSHIKI KAISHA, Osaka-shi, Osaka (JP)

(21) Appl. No.: 13/519,325

(22) PCT Filed: Dec. 2, 2010
(86) PCT No.: PCT/JP2010/071547

§ 371 Date: Jun. 27, 2012

(30) Foreign Application Priority Data
Jan. 7, 2010 (JP) 2010-002115

(51) Int. Cl. F21V 8/00; H04N 5/44; F21V 13/02; G02F 1/13357; F21V 29/00

(52) U.S. Cl. 348/725; 349/65; 362/611; 362/609; 362/613; 362/612; 348/E05.096

(57) ABSTRACT

In an edge-light type lighting device, expansion or contraction of the light guide plate is eliminated without bending or warping, and light sources and light entrance surfaces are not contacted with each other and not damaged. A backlight unit 24 includes an LED board 30, an LED light source 28 on a surface of the board 30, a plate-shaped light guide plate 20 having a light entrance surfaces 20a that are opposite side surfaces thereof and provided such that each entrance surface 20a faces the LED light source 28 on the LED board 30, and a holding member 19 provided to hold the LED board 30 and the light guide plate 20 in a thickness direction thereof. The holding member 19 includes a deformation allowance portion 36a that allows the guide plate 20 to be deformed in a planar direction thereof and a restriction portion 36b configured to restrict contact between the LED light source 28 and the entrance surface 20a of the guide plate 20.

### TECHNICAL FIELD

The present invention relates to a lighting device, a display device and a television receiver.

### BACKGROUND ART

In recent years, a type of a display element of an image display device including a television receiver has been shifted from a conventional CRT display device to a thin display device using a thin display element such as a liquid crystal panel and a plasma display and a thin image display device is made possible. A liquid crystal panel included in a liquid crystal display device does not emit light, and thus a backlight unit is required as a separate lighting device.

A backlight unit including light sources that are arranged on side surfaces of a light guide plate is known as an edge-light type backlight unit. The light sources are provided on a plurality of side surfaces of the light guide plate to obtain sufficient brightness in the edge-light type back light unit.

Patent documents 1 and 2 disclose a backlight unit including light sources that are arranged close to two side surfaces (light entrance surfaces) of the light guide plate that are provided on opposite sides. In the backlight unit of Patent Document 1, a transparent fixing member is provided between each light source and the light entrance surface of the guide plate and is configured to fix the each light source and the light entrance surface. In the backlight unit of Patent Document 2, each of the light sources and the light guide plate are not fixed. The light guide plate can be deformed in a planar direction.
Patent Document 1: Japanese Unexamined Patent Publication No. 2004-273185
Patent document 2: International Publication No. 2008/007487 Pamphlet

### PROBLEM TO BE SOLVED BY THE INVENTION

In a backlight unit, a light guide plate may be expanded or contracted due to heat generated in the vicinity of a light source in light emission. In the backlight unit of Patent Document 1, each of the two opposite light entrance surfaces of the light guide plate is fixed to the light sources by the fixing member. If the light guide plate is expanded or contracted, a stress produced within the light guide plate is not eliminated in the planar direction, and accordingly, the light guide plate is likely to bend or warp in the thickness direction. If the light guide plate bends or warps in the thickness direction, a gap is formed between the light guide plate and a reflection sheet that is provided on a surface of the light guide plate opposite to a light exit surface. This causes uneven brightness in the light exiting from the light exit surface of the light guide plate.

In the backlight unit of the Patent Document 2, if the light guide plate is deformed greatly toward the light source due to vibration or expansion of the light guide plate, the light guide plate may come in contact with the light source. If the light guide plate comes in contact with the light source, the contact surfaces of both the light guide plate and the light source are damaged. This causes deterioration in brightness.

### DISCLOSURE OF THE PRESENT INVENTION

The present invention was accomplished in view of the above circumstances. It is an object of the present invention to provide technology of eliminating expansion or contraction of the light guide plate without causing bending or warping in the light guide plate and preventing the light sources and the light entrance surfaces from coming in contact with each other and being damaged in case that expansion or contraction is caused in the light guide plate of an edge-light type lighting device including light sources arranged on side surfaces of a light guide plate. Another object of the present invention is to provide a display device including the lighting device and a television receiver including the display device.

### MEANS FOR SOLVING THE PROBLEM

To solve the above problem, a lighting device of the present invention includes a light source board, a light source arranged on a front surface of the light source board, a light guide plate formed in a plate shape, including light entrance surfaces on side surfaces of the light guide plate that are provided on opposite sides, each of the light entrance surface facing the light source of the light source board, and a holding member configured to hold at least the light source board and the light guide plate in a thickness direction thereof. The holding member includes a deformation allowance portion and a restriction portion. The deformation allowance portion is configured to allow the light guide plate to be deformed in a planar direction and the restriction portion is configured to restrict contact between the light source and each of the light entrance surfaces of the light guide plate.

In the lighting device, the light source is arranged on side surfaces of the light guide plate. The light guide plate is allowed to be deformed in the planar direction of the light guide plate with being held in the thickness direction thereof. If the light guide plate is deformed in the planar direction, the light entrance surface is prevented from coming in contact with the light source. Therefore, if the light guide plate is expanded or contracted, the expansion or contraction is eliminated without causing bending or warping in the light guide plate. Furthermore, the light source and the light entrance surfaces are prevented from coming in contact with each other and from being damaged each other.

In the lighting device, the holding member may include a main surface provided to face to the light guide plate, a first recess portion recessed from the main surface and housing a side edge of the light guide plate, and a second recess portion recessed from a bottom surface of the first recess portion and housing the light source board therein. The first recess portion may be configured to hold the light guide plate with side surfaces thereof such that the light guide plate is deformed in the planar direction of the light guide plate and to restrict contact between the light source and each of the light entrance surfaces of the light guide plate with the bottom surface of the first recess portion. The second recess portion may be configured to hold the light source board with a side surface thereof. Such a configuration specifically realizes the mounting of the holding member in the lighting device.

In the lighting device, the holding member may have a heat dissipation property. With such a configuration, heat generated in the vicinity of the light source is effectively dissipated outside the lighting device through the holding member. This reduces heat transferred to the light guide plate and reduces thermal expansion or contraction of the light guide plate.

In the lighting device, the light source board may include a side surface and a bottom surface, and at least one of the side surface and the bottom surface of the light source board may be in contact with the holding member having the heat dissipation property. With such a configuration, heat collected in the light source board is transferred directly to the holding member having a dissipation property, and accordingly, the dissipation of heat generated in the vicinity of the light source is improved.

The lighting device may further include a first reflection member. At least the light guide plate and the holding member may form and surround an enclosed space between the light source board and the light entrance surface and the light source may be housed in the enclosed space. The first reflection member may be provided on a surface of the holding member that is exposed to the enclosed space. With such a configuration, light dispersed from the light source outside the light guide plate is directed to the light guide plate by the first reflection member. Light is prevented from leaking out of the light guide plate, and accordingly, the use efficiency of light exiting from the light source is improved.

In the lighting device, the deformation allowance portion may be configured to allow the light guide plate to be deformed in the planar direction thereof with keeping the enclosed space. With such a configuration, even if the light guide plate is deformed to the maximum in the planar direction because of heat, the enclosed space is kept in space. Accordingly, light is prevented from leaking out of the light guide plate by the first reflection member.

In the lighting device, the deformation allowance portion may be configured to restrict bending and warping of the light guide member in a thickness direction thereof with keeping the enclosed space. With such a configuration, even if the light guide plate is thermally stressed in the thickness direction, the enclosed space is kept and bending or warping of the light guide plate is restricted. Accordingly, light is prevented from leaking out of the light guide plate by the first reflection member.

The lighting device may further include a second reflection member provided on the surface of the light source board. With such a configuration, light dispersed from the light source on a surface of the light source board is directed to the light guide plate by the second reflection member. This improves the light entrance efficiency of light entering the light guide plate from the light source.

In the lighting device, the reflection member may be a reflection sheet. With such a configuration, the reflection member is provided in accordance with the shape of surfaces of the holding member and the shape of surfaces of the light source board. Furthermore, the reflection sheet may be formed from a multilayer film using a polyester resin. Such a configuration improves the reflection efficiency of the reflection sheet and further improves the use efficiency of light emitted from the light source.

In the lighting device, the reflection member may be a resist configured to reflect light. With such a configuration, if the reflection sheet is not provided on a surface of the holding member or the light source board because of the shape of the surface, a material and the like of the holding member and the light source board, the resist is used as the reflection member by applying the resist that is configured to reflect light.

In the lighting device, the light source may include a plurality of light sources; and the plurality of light sources may be arranged linearly on the front surface of the light source board. Such a configuration realizes a lighting device in which a plurality of light sources is arranged and improves the brightness of the lighting device.

In the lighting device, the light source may be a light emitting diode. Such a configuration achieves a long lifetime and low power consumption of the light sources.

The light emitting diode may include a blue light emitting diode coated with a fluorescent material having an emission peak in a yellow range to emit white light. The light emitting diode may include a blue light emitting diode coated with a fluorescent material having an emission peak in a green range and a red range to emit white light. The light emitting diode includes a blue light emitting diode coated with a fluorescent material having an emission peak in a green range and a red light emitting diode to emit white light. The light emitting diode may include a blue light emitting diode, a green light emitting diode and a red light emitting diode to emit white light. With such a configuration, total color tone balance is achieved to obtain illumination light with uniform color tones.

The light emitting diode may include an ultraviolet light emitting diode and a fluorescent material. The light emitting diode may include an ultraviolet light emitting diode coated with a fluorescent material having an emission peak in a blue region, a green region and a red region to emit white light. With such a configuration, total color tone balance is achieved to obtain illumination light with uniform color tones.

The technology disclosed in the present invention may be described as a display device including a display panel configured to provide display using light from the lighting device. Furthermore, a display device configured to provide the display panel that is a liquid crystal panel using liquid crystal may be new and useful. Furthermore, a television receiver including the display device may be new and useful. The display device and the television receiver realize a large display area.

### ADVANTAGEOUS EFFECT OF THE INVENTION

According to technology disclosed in the description, in the edge-light type lighting device in which the light sources are arranged on both side surfaces of the light guide plate, if the light guide plate is expanded or contracted, the expansion or contraction is eliminated without bending or warping of the light guide plate, and furthermore, the light sources and the light entrance surfaces are prevented from coming in contact with each other and being damaged.

### BRIEF DESCRIPTION OF THE DRAWINGS

FIG. 1 is an exploded perspective view illustrating a television receiver TV according to a first embodiment;

FIG. 2 is an exploded perspective view illustrating a liquid crystal display device 10;

FIG. 3 is a vertical sectional view illustrating the liquid crystal display device 10;

FIG. 4 is a vertical sectional view illustrating a part of a backlight unit 24.

FIG. 5 is an enlarged perspective view illustrating a holding member 19;

FIG. 6 is an enlarged perspective view illustrating an LED unit 32;

FIG. 7 is a vertical sectional view illustrating a part of a backlight unit 54 according to a second embodiment; and

FIG. 8 is a vertical sectional view illustrating a part of a backlight unit 84 according to a third embodiment.

### BEST MODE FOR CARRYING OUT THE INVENTION

### First Embodiment

A first embodiment of the present invention will be described with reference to the drawings. An X axis, a Y-axis and a Z-axis are described in a part of the drawings, and a direction of each axial direction corresponds to a direction described in each drawing. A Y-axis direction matches a vertical direction and an X-axis direction matches a horizontal direction. Unless otherwise noted, a top to bottom direction will be explained based on a vertical direction.

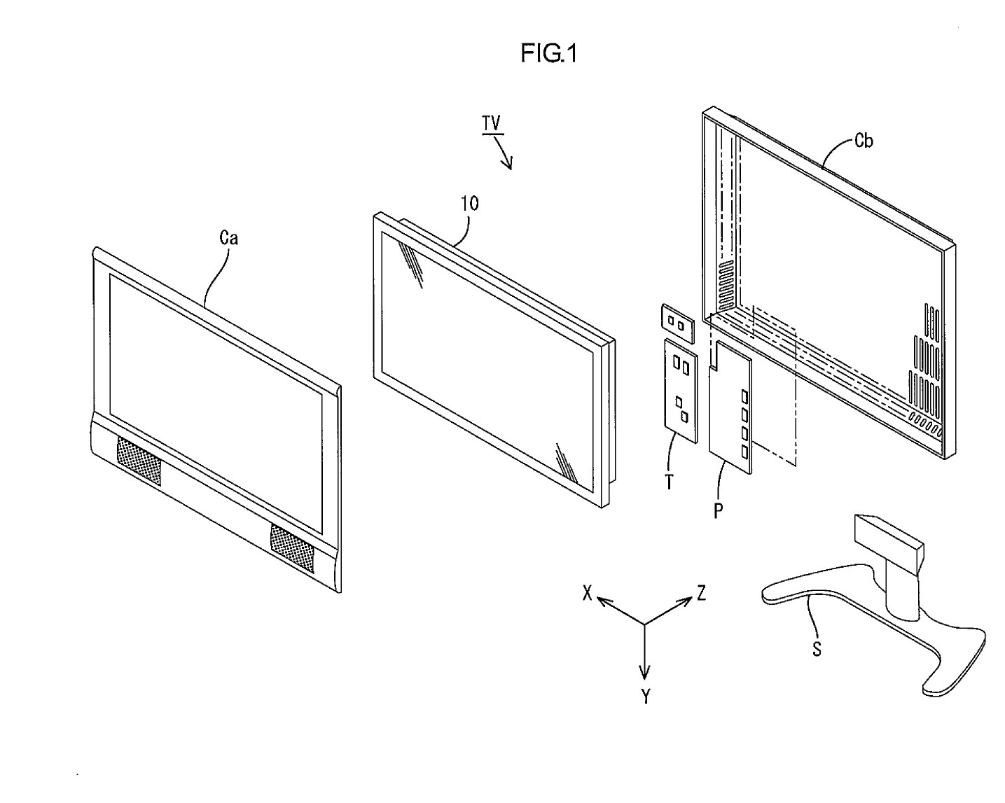

FIG. 1 illustrates an exploded perspective view of a television receiver TV according to a first embodiment of the present invention. As illustrated in FIG. 1, the television receiver TV includes the liquid crystal display device 10, front and rear cabinets Ca, Cb that house the liquid crystal display device 10 therebetween, a power source P, a tuner T and a stand S.

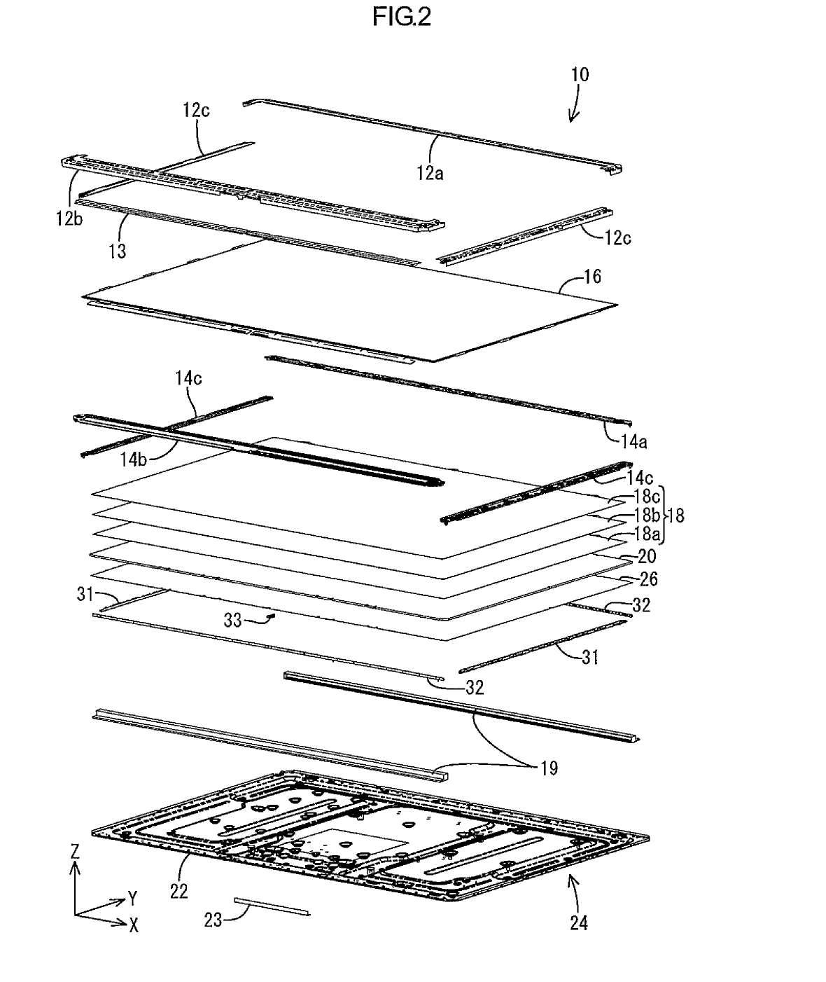

FIG. 2 schematically illustrates a horizontal sectional view of the display device 10. An upper side in FIG. 2 corresponds to a front-surface side and a lower side in FIG. 2 corresponds to a rear-surface side. An entire shape of the liquid crystal display device 10 is a landscape rectangular. As illustrated in FIG. 2, the liquid crystal display device 10 includes a liquid crystal panel 16 as a display panel, and a backlight unit 24 as an external light source. The liquid crystal panel 16 and the backlight unit 24 are integrally held by a top bezel 12a, a bottom bezel 12b, side bezels 12c (hereinafter a bezel set 12a to 12c) and the like.

As illustrated in FIG. 2, the liquid crystal panel 16 included in the liquid crystal display device 10 is formed in a rectangular plan view shape. A long-side direction of the liquid crystal panel 16 matches a horizontal direction (an X-axis direction) and a short-side direction thereof matches a vertical direction (a Y-axis direction). The liquid crystal panel 12 is configured such that a pair of transparent glass substrates (highly capable of light transmission) is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, and an alignment film and the like are provided. On the other substrate, color filters having color sections such as R (red), G (green) and B (blue) color sections arranged in a predetermined pattern, counter electrodes, and an alignment film and the like are provided. A drive circuit board (not shown) supplies image data and various control signals that are necessary to display images to the source lines, the gate lines and the counter electrodes. Polarizing plates (not shown) are attached to outer surfaces of the substrates.

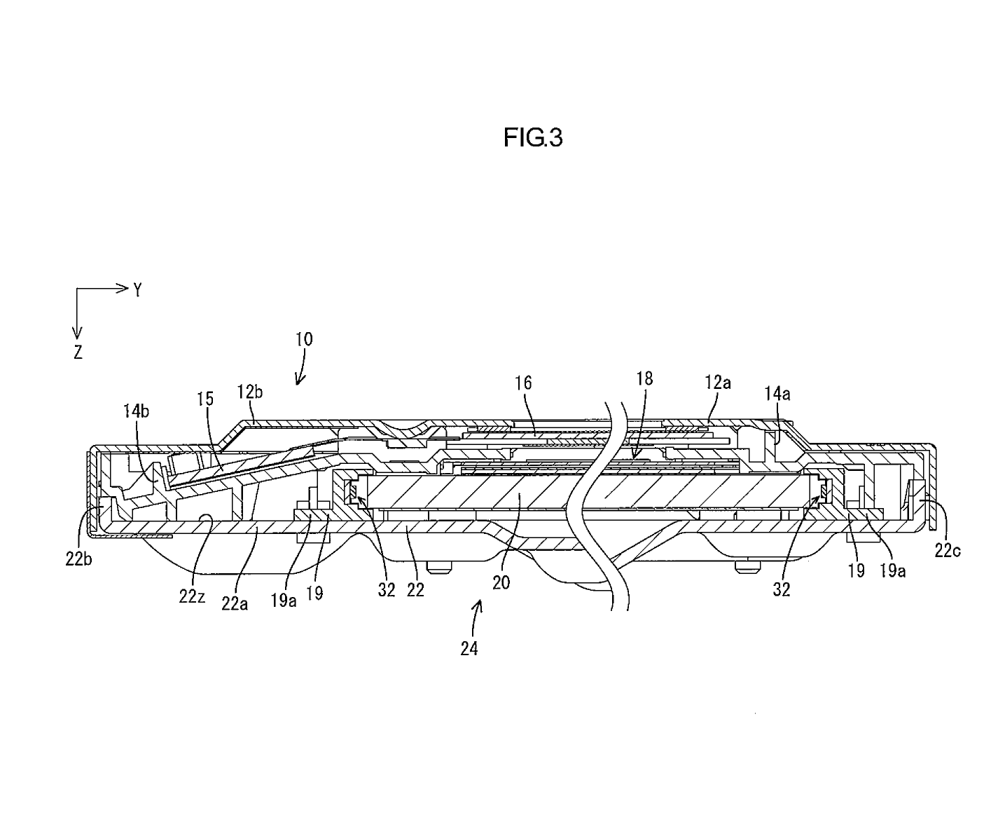

The backlight unit 24 will be described. As illustrated in FIG. 2, the backlight unit 24 includes a backlight chassis 22, optical members 18, a top frame 14a, a bottom frame 14b and side frames 14c (hereinafter a frame set 14a to 14c). The liquid crystal panel 16 is sandwiched between the bezel set 12a to 12c and the frame set 14a to 14c. A reference numeral 13 represents an insulating layer configured to insulate a driving circuit board 15 (see FIG. 3) for driving the liquid crystal panel 16. The substantially box-shaped backlight chassis 22 has an opening on the front-surface side (on the light exit side and the liquid crystal panel 16 side). Furthermore, the backlight chassis 22 houses a pair of cable holders 31 and 31, a pair of LED (light emitting diode) units 32 and 32, a light guide plate 20 and a pair of the holding members 19 and 19 in the backlight chassis 22. A power supply circuit board (not shown) configured to supply power to the LED units 32 and a protection cover 23 for protecting the power supply circuit board are mounted on the rear side of the backlight chassis 22.

The pair of cable holders 31 and 31 is arranged in the short-side direction of the backlight chassis 22 and holds cables electrically connected between the LED units 132 and the power supply circuit board. The pair of LED units 32 and 32 extends along respective long sides of the backlight chassis 22. The LED units 32 and 32 are arranged inside the holding members 19 and are configured to emit light. The light guide plate 20 is provided between the pair of holding members 19 and 19 and is configured to guide light emitted from the LED units 32 toward the liquid crystal panel 16. The optical members 18 are provided on the front-surface side of the light guide plate 20. The light reflection sheet 26 is provided on the rear-surface side of the light guide plate 20. The LED units 32, the light guide plate 20 and the light reflection sheet 26 are supported each other by a rubber bushing 33. The pair of holding members 19 and 19 extends along respective long sides of the backlight chassis 22 and holds the side edge of the long-sides of the light guide plate 20 in the thickness direction thereof (in the Y-axis direction). The light guide plate 20 and the optical members 18 are provided directly below the liquid crystal panel 16, and each LED unit 32 as a light source is provided at the side edge of the light guide plate 20. Namely, an edge light type (side light type) is used for the backlight unit 24 of the present embodiment.

The optical members 18 include laminated layers of a diffuser sheet 18a, a lens sheet 18b and a reflecting type polarizing sheet 18c in this order from the light guide plate 20 side. The diffuser sheet 18a, the lens sheet 18b and the reflecting type polarizing sheet 18c have a function for making planar light from light exiting from LED units 32. The liquid crystal panel 16 is provided on the front surface side of the reflecting type polarizing sheet 18c. The optical members 18 are provided between the light guide plate 20 and the liquid crystal panel 16.

The LED unit 32 includes an LED board 30 and LED light sources 28. The rectangular LED board 30 is made from resin. The LED light sources 28 configured to emit white light are arranged linearly in a line on the LED board 30. The pair of LED units 32 and 32 is mounted inside the holding members 19 with screws and the like such that the LED light sources 28 arranged on each of the LED units 32 face each other. Each of the LED light source 28 may include a blue light emitting diode coated with a fluorescent material having an emission peak in a yellow range to emit white light. The LED light source 28 may include a blue light emitting diode coated with a fluorescent material having an emission peak in a green range and a red range to emit white light. The LED light source 28 may include a blue light emitting diode coated with a fluorescent material having an emission peak in a green range and a red light emitting diode to emit white light. The LED light source 28 include a blue light emitting diode, a green light emitting diode and a red light emitting diode to emit white light. The LED light source 28 may include an ultraviolet light emitting diode and a fluorescent material. Particularly, the LED light source 28 may include an ultraviolet light emitting diode coated with a fluorescent material having an emission peak in a blue range, a green range and a red range to emit white light.

The light guide plate 20 formed in a rectangular plate shape is made from a resin highly capable of light transmission (or with high clarity) such as acrylic. As illustrated in FIG. 2, the light guide plate 20 is provided between the holding members 19 facing each other such that the main plate of the light guide plate 20 faces to the diffuser sheet 18a. The light reflection sheet 26 is provided on a surface 20c of the light guide plate 20 that is opposite to a surface (light exit surface) 20b facing the diffuser sheet 18a. The light reflection sheet 26 reflects light leaking out of the light guide plate 20 and returns the light to the light guide plate 20. With such a configuration, light exiting from the LED units 32 enters the side plate surface (light entrance surface) 20a of the light guide plate 20 and exits the main plate surface (light exit surface) 20b thereof facing the diffuser sheet 18a. Accordingly, the light radiates the liquid crystal panel 16 from the rear side thereof.

FIG. 3 illustrates a vertical sectional view of the liquid crystal display device 10. The backlight chassis 22 is formed in a rectangular plan view shape and made of metal such as aluminum material. As illustrated in FIG. 3, the backlight chassis 22 includes the bottom plate 22a having a bottom surface 22z and the side plates 22b and 22c each of which rises shallowly from an outer edge of the corresponding side of the bottom plate 22a toward the front surface side. The long-side direction of the bottom plate 22a matches a horizontal direction (X-axis direction). The short-side direction of the bottom plate 22a matches a vertical direction (Y-axis direction). Each holding member 19 is substantially formed in a U-shape with a vertical sectional view. The bottom surfaces 19a of the holding members 19 are fixed to the bottom plate 22a of the backlight chassis 22. Each LED unit 32 is fixed to the inner surfaces of the holding member 19 such that each of the light emitting surfaces faces the light entrance surface 20a of the light guide plate 20. The holding members 19 are heat dissipative. The holding members 19 dissipate heat generated in the LED units 32 outside the backlight unit 24 through the bottom plate 22a of the backlight chassis 22.

As illustrated in FIG. 3, the holding members 19 hold the LED units 32 and the side edges of the light guide plate 20. The frame set 14a to 14c and the backlight chassis 22 hold the light guide member 20 and the optical members 18. As illustrated in FIG. 3, the driving circuit board 15 is provided on the front-surface side of the bottom frame 14b. The driving circuit board 15 is electrically connected to the liquid crystal panel 16 to supply image data and various control signals that are necessary to display images with the liquid crystal panel 16.

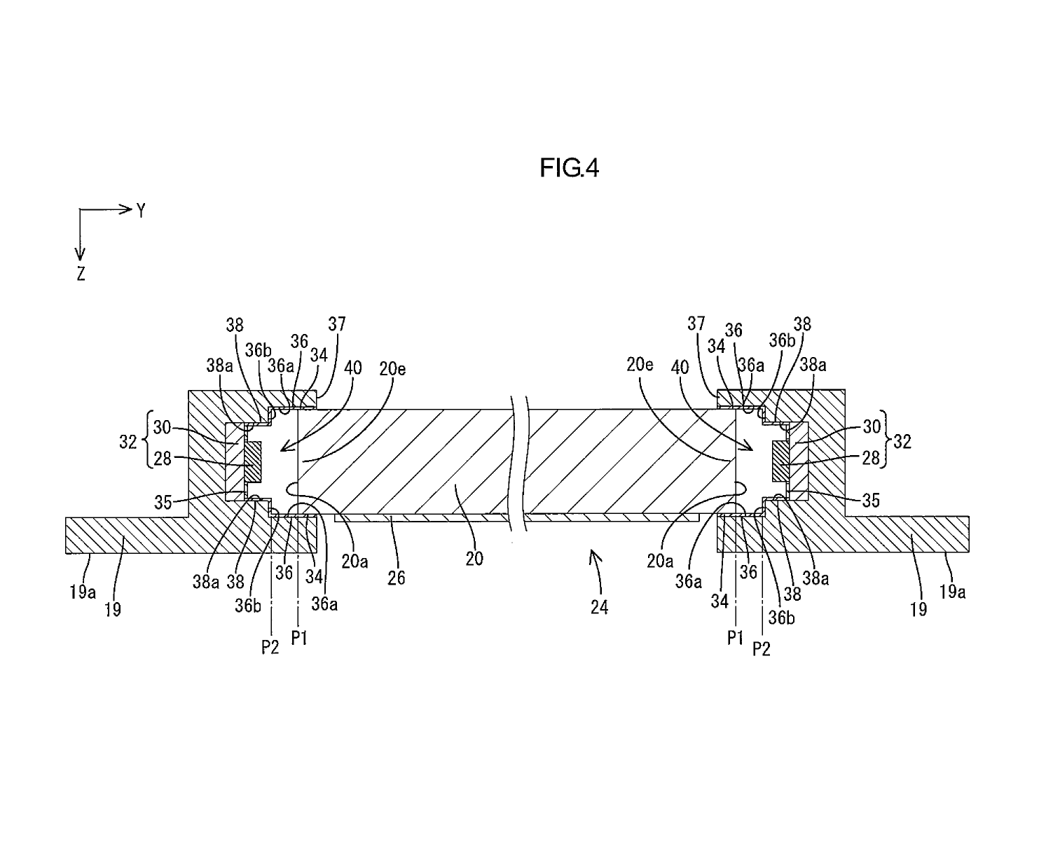

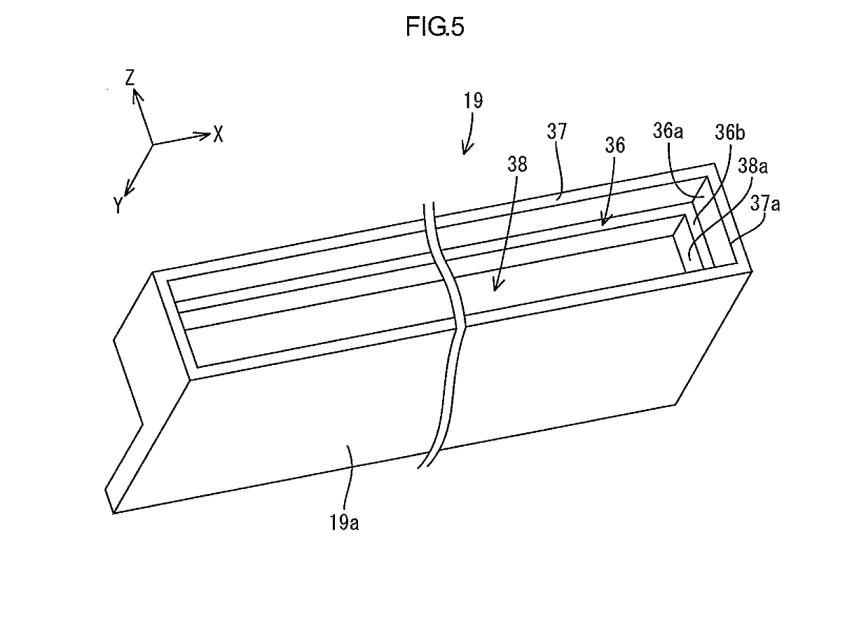

FIG. 4 partially illustrates a vertical sectional view of the backlight unit 24 and FIG. 5 illustrates an enlarged perspective view of the holding member 19. FIG. 4 shows sections of a pair of the holding members 19 and 19, a pair of the LED units 32 and 32, the light guide plate 20 and the light reflection sheet 26. As illustrated in FIG. 4, each holding member 19 is in contact with the upper surface, the lower surface and the bottom surface (a surface that is opposite from a surface on which LED light sources 28 are mounted) of the LED board 30. As illustrated in FIGS. 4 and 5, the holding member 19 includes a main surface 37, a first recess portion 36, a bottom surface 36b and a second recess portion 38. The main surface 37 is provided to face to the light guide plate 20. The first recess portion 36 is recessed from the main surface 37. The second recess portion 38 is further recessed from the bottom surface 36b of the first recess portion 36.

The first recess portion 36 is formed so as to house the side end 20e of the light guide plate 20. The side surfaces 36a of the first recess portion 36 hold the light guide plate 20. Each side surface 36a of the first recess portion 36 includes a surface that extends at least in the short-side direction of the backlight chassis 22. The extended surface provides an allowance for the deformation of the side end 20e of the light guide plate 20 according to the extending size of the extended surface in the short-side direction of the backlight chassis 22. The bottom surface 36b of the first recess portion 36 is provided more closely to the light entrance surface 20a than the LED light source 28 and provided in parallel with the light entrance surface 20a of the light guide plate 20. Accordingly, the bottom surface 36b of the first recess portion 36 restricts the contact between the LED light source 28 and the light entrance surface 20a of the light guide plate 20. The second recess portion 38 is formed so as to house the LED board 30 therein. Each side surface 38a of the second recess portion 38 includes a surface that extends at least in the short-side direction of the backlight chassis 22. The surfaces hold the LED board 30. The holding member 19 has the bottom plate portion 19a arranged along the bottom surface 22z of the backlight chassis 22. The bottom plate portion 19a is fastened with screws to mount the holding member 19 on the bottom plate 22a of the backlight chassis 22.

As illustrated in FIG. 5, the holding member 19 has an opening 37a that is open on the main surface 37 side through the first recess portion 36. The shape of the opening 37a is substantially the same as the light entrance surface 20a of the light guide plate 20. The side end 20e of the light guide plate 20 is housed in the first recess portion 36 so as to cover the opening 37a. As illustrated in FIG. 4, the side end 20e of the light guide plate 20 is housed in the first recess portion 36 of the holding member 19. Accordingly, an enclosed space 40 that is surrounded by the light guide plate 20 and the holding member 19 is formed between the LED board 30 and the light entrance surface 20a of the light guide plate 20. The LED light source 28 is housed in the enclosed space 40. Moreover, a reflection sheet (first reflection member) 34 is provided on a surface of the holding member 19 that is exposed to the enclosed space 40. The reflection sheet 34 is configured to reflect light from the LED light source 28.

In FIG. 4, the light entrance surface 20a is located in a position P1 with respect to the vertical direction if the light guide plate 20 is not expanded or contracted. The light entrance surface 20a is located in a position P2 with respect to the vertical direction if the light guide plate 20 is expanded maximally in the vertical direction. As illustrated in FIG. 4, the side surface 36a of the first recess portion 36 extends from the position P1 to the position P2. Therefore, the side surface 36a of the first recess portion 36 allows the light entrance surface 20a to be deformed between the position P1 and the position P2 according to the extending size of the side surface 36a along the short-side direction of the backlight chassis 82. The enclosed space 40 is kept in space while the light entrance surface 20a is deformed from the position P1 to the position P2.

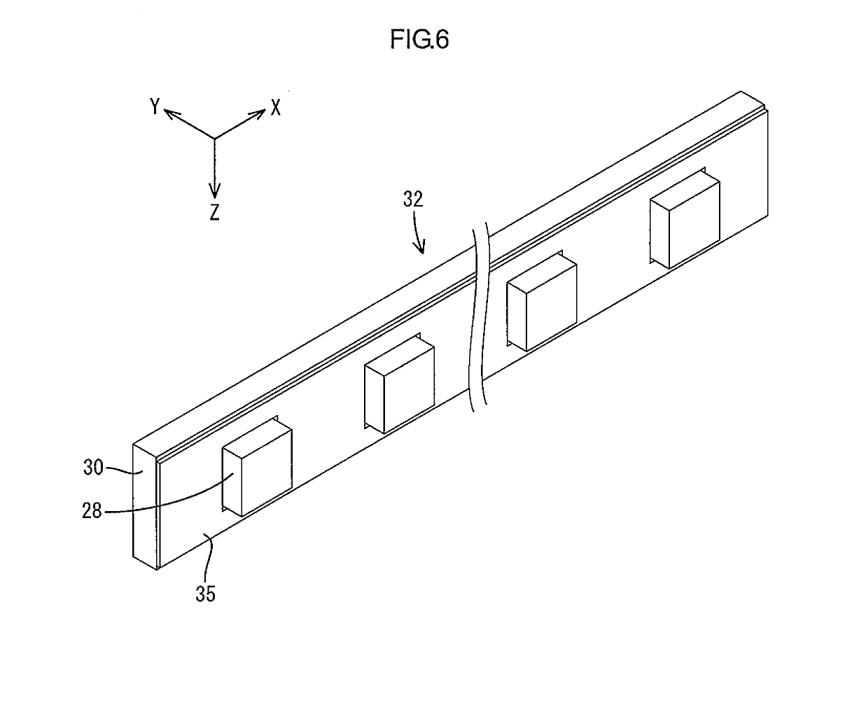

FIG. 6 illustrates an enlarged perspective view of the LED unit 32. As illustrated in FIG. 6, a reflection sheet (second reflection member) 35 is provided on a front surface of the LED board 30 and in a portion thereof having no LED light sources 28. The reflection sheet 35 is configured to reflect light. The reflection sheet 35 directs light that is dispersed on the surface of the LED board 30 from the LED light sources 28 to the light guide plate 20.

The television receiver TV of the present embodiment has been described in detail. In the backlight unit 24 of the television receiver TV according to the present embodiment, the LED units 32 are arranged in the long sides of the light guide plate 20. The light guide plate 20 is deformed in the planar direction thereof with being held in the thickness direction thereof. Furthermore, the light entrance surface 20a is prevented from coming in contact with the LED light source 28 if the light guide plate 20 is deformed in the planar direction. Accordingly, if the light guide plate 20 is expanded or contracted, the expansion or contraction is eliminated without bending or warping of the light guide plate 20. Furthermore, the LED light source 28 and the light entrance surface 20a are prevented from coming in contact with each other and being damaged.

In the present embodiment, the holding members 19 are heat dissipative. Heat generated near the LED units 32 is dissipated outside the backlight unit 24 through the holding members 19. This reduces heat transferred to the light guide plate 20 and reduces thermal expansion or contraction thereof. Furthermore, the holding member 19 is in contact with the upper side surface, the lower side surface and the bottom surface (the rear surface) of the LED board 30, and therefore, heat that is generated in the vicinity of the LED light source 28 is effectively dissipated.

In the present embodiment, the enclosed space 40 is formed between the LED board 28 and the light entrance surface 20a. The reflection sheet 34 is provided on the surface of the holding member 19 that is exposed to the enclosed space 40. Accordingly, light dispersed from the LED unit 32 outside the light guide plate 20 is directed to the light guide plate 20 by the reflection sheet 34. This reduces light that leaks out of the light guide plate 20 and improves use efficiency of light exiting from the LED unit 32.

In the present embodiment, the side surface 36a of the first recess portion 36 allows the light entrance surface 20a of the light guide plate 20 to be deformed from the position P1 to the position P2 with keeping the enclosed space 40 in space. Furthermore, the side surface 36a of the first recess portion 36 restricts bending or warping of the light guide plate 20 in the thickness direction with keeping the enclosed space 40. Therefore, even if the light guide plate 20 is deformed maximally in the short-side direction of the backlight chassis 22 due to thermal expansion and the like or the light guide plate 20 is thermally stressed in the thickness direction thereof, the enclosed space 40 is kept in space. Therefore, the reflection sheet 34 prevents the leakage of light out of the light guide plate 20.

Furthermore, in the present embodiment, the reflection sheet 35 is provided on the front surface of the LED board 30. Accordingly, light dispersed on the front surface of the LED board 30 from the light source 28 is directed to the light guide plate 20 by the reflection sheet 35. This improves entrance efficiency of light entering the light guide plate 20 from the LED light source 28.

In the present embodiment, a plurality of light sources 28 is arranged linearly on the front surface of the LED board 30 to achieve illumination light with high brightness.

In the present embodiment, the LEDs 28 are used as light sources. This achieves a long lifetime and low power consumption. Furthermore, for example, each of the LED light source 28 includes a blue light emitting diode coated with a fluorescent material having an emission peak in a yellow range to emit white light. Accordingly, total color tone balance is achieved to provide illumination light with uniform color tones.

### Second Embodiment

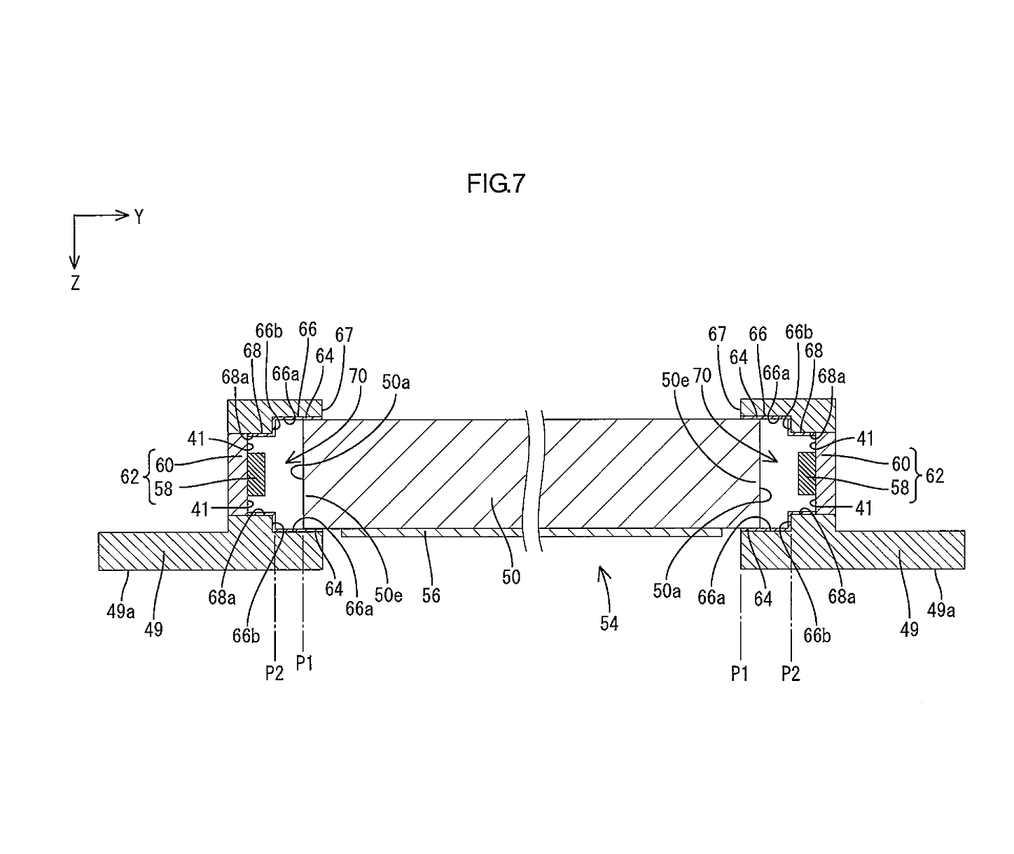

FIG. 7 partially illustrates a vertical sectional view of a backlight unit 54 according to a second embodiment of the present invention. The second embodiment is different from the first embodiment in a holding member 49, a first reflection member 64 and a surface of an LED board 60. Other components are same as those in the first embodiment and the construction, operations and effects as same as the first embodiment will not be explained. The members in FIG. 7 denoted by reference numerals that thirty is added to the reference numerals in FIG. 4 are the same members explained in the first embodiment. FIG. 7 illustrates a sectional view of a part corresponding to the part explained in FIG. 4 in the first embodiment.

In the backlight unit 54 of the second embodiment, the holding member 49 includes a main surface 67, a first recess portion 66, and a through hole 68. The main surface 67 is provided to face to a light guide plate 50. The first recess portion 66 is recessed from the main surface 67. The through hole 68 is formed from a bottom surface 66b of the first recess portion 66 through a surface 49b that is opposite to a surface facing the light entrance surface 50a. The construction of the first recess portion 66 is the same as that of the first embodiment.

The shape of the horizontal section of the through hole 68 is substantially the same as that of the LED board 60. As illustrated in FIG. 7, a side end 50e of the light guide member 50 is housed in the holding member 49. An enclosed space 70 is formed between the LED board 60 and the light entrance surface 50a of the light guide plate and surrounded by the light guide plate 50, the holding member 49 and the LED board 60. In the present embodiment, even if the light guide plate 50 is deformed maximally in the short-side direction of the backlight chassis due to thermal expansion and the like, the enclosed space 70 is kept in space. Therefore, the leakage of light out of the light guide plate 50 is prevented by the first reflection sheet 64.

In the backlight unit 54 of the second embodiment, the reflection sheet (first reflection member) 64 is provided on the surface of the holding member 49 that is exposed to the enclosed space 70 and configured to reflect light. The reflection sheet 64 is formed from a multilayer film using a polyester resin. This improves the reflection efficiency of the reflection sheet 64 and further improves the use efficiency of light exiting from the LED unit 72.

In the backlight unit 54 of the second embodiment, a white resist (a second reflection member) 41 is applied to a part of the surface of the LED board 60 in which the LED light source 58 is not provided. The resist 41 is configured to reflect light from the LED light source 58. If a reflection sheet cannot be provided on the surface of the holding member 49 and the LED board 60 due to the shape of the surface, a material and the like of the holding member 49 and the LED board 60, the resist 41 is used as a reflection member by applying the resist that reflects light.

### Third Embodiment

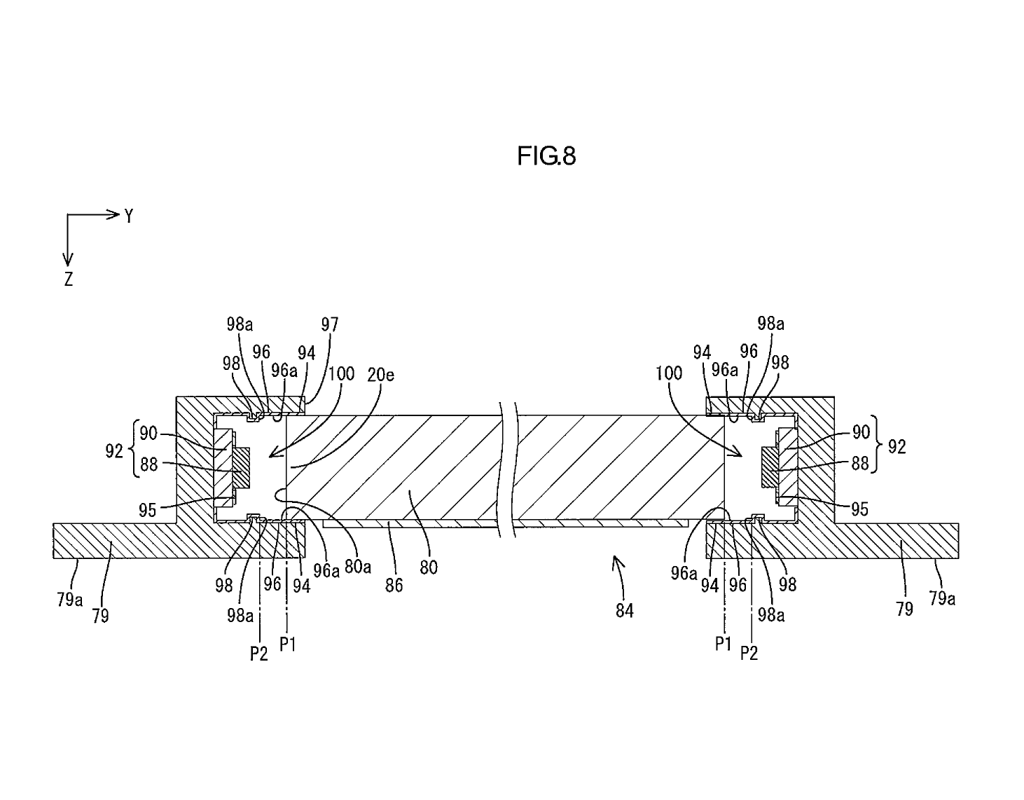

FIG. 8 partially illustrates a sectional view of a backlight unit 84 according to a third embodiment of the present invention. The backlight unit 84 of the third embodiment includes a holding member 79 that is different from the first embodiment. The construction, operations and effects as same as the first embodiment will not be explained. The members in FIG. 8 denoted by reference numerals that 60 is added to those in FIG. 4 are the same members explained in the first embodiment. FIG. 8 illustrates a sectional view of a part corresponding to the part explained in FIG. 4 in the first embodiment.

The holding member 79 includes a main surface 97 and a recess portion 96 in a backlight unit 84 of the third embodiment. The main surface 97 is provided to face to the light guide plate 50 and the recess portion 96 is recessed from the main surface 97. A projection portion 98 is provided to project shallowly from a side surface of the recess portion 96 toward a direction so as to be away from the recess portion 96. The projection portion 98 is arranged all along the side surface of the recess portion 96. The projection portion 98 is provided more closely to the light entrance surface 80a of the light guide plate 80 than the LED light source 88. The projection portion 98 has a facing surface 98a that face the light entrance surface 80a of the light guide plate 80 so as to be in parallel with each other. Accordingly, the projection portion 98 restricts the contact between the LED light source 88 and the light entrance surface 80a of the light guide plate 80 and prevents the LED light source 88 and the light entrance surface 80a from coming in contact with each other and being damaged.

A first side surface 96a that is a side surface of the recess portion 96 is provided more closely to the light guide plate 80 than the projection portion 98. The first side surface 96a allows the light entrance surface 80a of the light guide plate 80 to be deformed from the position P1 to the position P2 with keeping the enclosed space 100 in space according to a size of the first side surface 96 that extends in the short-side direction of the backlight chassis 82. With the configuration of the present embodiment, even if the light guide plate 80 is deformed maximally in the short-side direction of the backlight chassis due to expansion and the like of the light guide plate 80, the enclosed space 100 is kept in space. Therefore, the leakage of light out of the light guide plate 80 is prevented by the first reflection member 94.

Correspondence relationships between the construction of the embodiments and the construction of the present invention will be described. The LED light sources 28, 58 and 88 are an example of a “light source.” The LED boards 30, 60, and 90 are an example of a “light source board.” The side surfaces 36a and 66a of the first recess portion and the first side surface 96a of the recess portion are an example of a “deformation allowance portion.” The bottom surfaces 36b and 66b of the first recess portion and the facing surface 98a are an example of a “restriction portion.” The backlight units 24, 54 and 84 are an example of a “lighting device.” The liquid crystal device 10 is an example of a “display device.”

### Other Embodiments

In the following, modifications of the above embodiments will be explained.

(1) In the above embodiments, the LED light sources are provided to face the two side surfaces that are provided on opposite sides of the light guide plate. However, the LED light sources may be arranged on three side surfaces of the light guide plate or all (four) side surfaces thereof.

(2) In the above embodiments, the holding members are mounted on the bottom plate of the backlight chassis. The method of fixing the holding members may be altered. For example, the holding members may be mounted on the side plate of the backlight chassis.

(3) The configuration of the holding members may be altered if necessary.

In the above embodiments, the liquid crystal display device including the liquid crystal panel as a display panel is described. The technology can be applied to display devices including other types of display components.

In the above embodiments, the television receiver including the tuner is used. However, the technology can be applied to a display device without a tuner.

The embodiments of the present invention have been described in detail. The embodiments are for illustrative purposes only and by no means limit the scope of the present invention. Technologies described in the present invention include variations and modifications of the embodiments and examples described above.

The technical elements described or shown in the specification or drawings exhibit the technical usefulness individually or in various combinations thereof. The technical elements are not limited to the combinations defined in the claims at the time of filing the application. Furthermore, the technologies illustrated in the specification or drawings realize a plurality of purposes at the same time and have a technical usefulness when one of the purposes is realized.

### EXPLANATION OF SYMBOLS

TV: television receiver, Ca, Cb: cabinet, T: tuner, T: stand, 10: liquid crystal display device, 12a: top bezel, 12b: bottom bezel, 12c: side bezel, 13: insulating layer, 14a: top frame, 14b: bottom frame, 14c side frame, 15: driving circuit board, 16: liquid crystal panel, 18: optical member, 18a: diffuser sheet, 18b: lens sheet, 18c: reflecting type polarizing sheet, 19: holding member, 19a: bottom plate portion, 20, 50, 80: light guide plate, 20a, 50a, 80a: light entrance surface, 20b: light exit surface, 20c: surface opposite to light exit surface, 22, 52, 82: backlight chassis, 22a: bottom plate, 22z: bottom surface, 23: protection cover, 24, 54, 84: backlight device, 26, 56, 86: light reflection sheet, 28, 58, 88: LED light source, 30, 60, 90: LED board, 31: cable holder, 32, 62, 92: LED unit, 33: rubber bushing, 34, 64, 94: first reflection sheet, 35, 41, 95: second reflection sheet, 36, 66: first recess portion, 36a, 66a: side surface of first recess portion (deformation allowance portion), 36b, 66b: bottom surface of the first recess portion (restriction portion), 38, 68: second recess portion, 38a, 68a: side surface of second recess portion, 40, 70, 100: enclosed space, 96: recess portion, 96a: first side surface of recess portion (deformation allowance), 98: projection portion, 98a: facing surface

1. A lighting device comprising:
a light source board;
a light source arranged on a front surface of the light source board;
a light guide plate formed in a plate shape, including light entrance surfaces on side surfaces of the light guide plate that are provided on opposite sides, each of the light entrance surface facing the light source of the light source board; and
a holding member configured to hold at least the light source board and the light guide plate in a thickness direction thereof, the holding member including a deformation allowance portion and a restriction portion, the deformation allowance portion being configured to allow the light guide plate to be deformed in a planar direction and the restriction portion being configured to restrict contact between the light source and each of the light entrance surfaces of the light guide plate.

2. The lighting device according to claim 1, wherein:
the holding member includes a main surface provided to face to the light guide plate, a first recess portion recessed from the main surface and housing a side edge of the light guide plate, and a second recess portion recessed from a bottom surface of the first recess portion and housing the light source board therein;
the first recess portion is configured to hold the light guide plate with a side surface thereof such that the light guide plate is deformed in the planar direction of the light guide plate and to restrict contact between the light source and each of the light entrance surfaces of the light guide plate with the bottom surface of the first recess portion; and
the second recess portion is configured to hold the light source board with a side surface thereof.

3. The lighting device according to claim 1, wherein the holding member has a heat dissipation property.

4. The lighting device according to claim 3, wherein:
the light source board includes a side surface and a bottom surface; and
at least one of the side surface and the bottom surface of the light source board is in contact with the holding member having the heat dissipation property.

5. The lighting device according to claim 1, further comprising a first reflection member, wherein:
at least the light guide plate and the holding member form and surround an enclosed space between the light source board and the light entrance surface, and the light source is housed in the enclosed space; and
the first reflection member is provided on a surface of the holding member that is exposed to the enclosed space.

6. The lighting device according to claim 5, wherein the deformation allowance portion is configured to allow the light guide plate to be deformed in the planar direction thereof with keeping the enclosed space.

7. The lighting device according to claim 5, wherein the deformation allowance portion is configured to restrict bending or warping of the light guide member in a thickness direction thereof with keeping the enclosed space.

8. The lighting device according to claim 1, further comprising a second reflection member provided on the front surface of the light source board.

9. The lighting device according to claim 5, wherein the reflection member is a reflection sheet.

10. The lighting device according to claim 9, wherein the reflection sheet is formed from a multilayer film using a polyester resin.

11. The lighting device according to claim 5, wherein the reflection member is a resist configured to reflect light.

12. The lighting device according to claim 1, wherein:
the light source includes a plurality of light sources; and
the plurality of light sources is arranged linearly on the surface of the light source board.

13. The lighting device according to claim 1, wherein the light source is a light emitting diode.

14. The lighting device according to claim 13, wherein the light emitting diode includes a blue light emitting diode coated with a fluorescent material having an emission peak in a yellow range to emit white light.

15. The lighting device according to claim 13, wherein the light emitting diode includes a blue light emitting diode coated with a fluorescent material having an emission peak in a green range and a red range to emit white light.

16. The lighting device according to claim 13, wherein the light emitting diode includes a blue light emitting diode coated with a fluorescent material having an emission peak in a green range and a red light emitting diode to emit white light.

17. The lighting device according to claim 13, wherein the light emitting diode includes a blue light emitting diode, a green light emitting diode and a red light emitting diode to emit white light.

18. The lighting device according to claim 13, wherein the light emitting diode includes an ultraviolet light emitting diode and a fluorescent material.

19. The lighting device according to claim 13, wherein the light emitting diode includes an ultraviolet light emitting diode coated with a fluorescent material having an emission peak in a blue region, a green region and a red region to emit white light.

20. A display device comprising:
the lighting device according to claim 1; and
a display panel configured to provide display using light from the lighting device.

21. The display device according to claim 20, wherein the display panel is a liquid crystal panel using liquid crystals.

22. A television receiver comprising the display device according to claim 20.
